(19) United States
(12) Patent Application Publication
(10) Pub. No.: US 2018/0268451 A1
(43) Pub. Date: Sep. 20, 2018

(54) SYSTEM FOR COLLABORATIVE TRANSACTIONS

(71) Applicant: HIODZ Limited, Hong Kong (HK)

(72) Inventor: Ric B. Richardson, Tyagarah (AU)

(73) Assignee: HIODZ Limited, Hong Kong (HK)

(21) Appl. No.: 15/971,447

(22) Filed: May 4, 2018

Related U.S. Application Data
(63) Continuation of application No. 14/504,880, filed on Oct. 2, 2014, now abandoned.
Application No. 14/504,880 is a continuation of application No. 13/640,957, filed on Oct. 12, 2012, now abandoned.

(30) Foreign Application Priority Data
Apr. 12, 2010 (AU) 20100001535

(51) Int. Cl. G06Q 30/06; G06Q 30/00; G06Q 30/02; G06Q 30/08

(52) U.S. Cl. CPC G06Q 30/0605; G06Q 30/08; G06Q 30/0208; G06Q 30/00

(57) ABSTRACT

A dedicated device for permitting time-based collaborative contributions for services, said dedicated device in communication with a database; the dedicated device adapted to receive input from one or more users; said device permitting said users individually and separately to make a contribution in a predetermined amount towards a designated target contribution amount.

This application is a continuation of U.S. application Ser. No. 14/504,880 filed Oct. 2, 2014, which is a continuation of U.S. National Phase application Ser. No. 13/640,957 filed Oct. 12, 2012, which claims priority to PCT Application Serial No. PCT/AU2011/000416 filed Apr. 12, 2011, which claims priority to Australian Patent Application No. AU2010001535 filed Apr. 12, 2010, the disclosures of which are hereby incorporated by reference in their entirety.

The present invention relates to a system for collaborative transactions and related apparatus and methods.

### BACKGROUND

Broadly it can be stated that the problem is to provide a device, a mechanism or a methodology by which entities can participate in a transaction which incorporates at least two parameters which the entity has the ability to trade off one against the other in a fully informed manner. In one preferred form the first parameter is the value of a good or service and the second parameter is the probability of gaining title to the good or service (or at least gaining the benefit of the good or service). In everyday situations a user has no ability to trade off these two parameters—the entity either makes a decision to pay full value and have 100% probability of gaining title (or pay zero value and have zero probability of gaining title). Embodiments of the present invention permit an entity to operate in a range between these two extremes.

Embodiments of the present invention seek to expand on these services by allowing multiple people to contribute to the purchase of almost any product from almost any supplier or seller allowing contributors to help purchase products for others and to allow sellers from online marketplaces to enable lay away type sales arrangements. An alternative embodiment also disclosed allows multiple contributors to enter a lottery or raffle to win, rather than acquire, a particular prize.

### Notes

The term “comprising” (and grammatical variations thereof) is used in this specification in the inclusive sense of “having” or “including”, and not in the exclusive sense of “consisting only of”.

The above discussion of the prior art in the Background of the invention is not an admission that any information discussed therein is citable prior art or part of the common general knowledge of persons skilled in the art in any country.

### BRIEF DESCRIPTION OF INVENTION

In one broad form of the invention there is provided a ticketing system whereby a predetermined number of tickets are made available for distribution for a specified transaction for a predetermined period of time; and whereby the transaction must be completed by no later than said predetermined period of time; and wherein said predetermined number is publicised; and wherein said predetermined time is publicised; and wherein the transaction result is publicised; and wherein if said tickets are all distributed by said predetermined time or earlier than said predetermined time then one ticket is randomly selected and the entity associated with that ticket is awarded the benefit of the transaction.

In yet a further broad form of the invention there is provided a method of awarding the benefit of a transaction to one entity from a plurality of entities which collaborate on said transaction; said method comprising the steps of: publicising the benefit of the transaction; publicising a predetermined period of time by which the transaction must be concluded; publicising a predetermined number comprising the number of contribution portions which will comprise the transaction; distributing said predetermined number of contribution portions to said entities within said predetermined period of time; and wherein if said predetermined number of contribution portions are all distributed by said predetermined time or earlier than said predetermined time then one contribution portion is selected and the entity associated with that contribution portion is awarded the benefit of the transaction.

Preferably said contribution portion is equal in value to all other contribution portions which comprise said transaction.

Preferably the probability of any one contribution portion being selected is equal to that of any other contribution portion being selected.

Preferably a contribution portion is represented by a ticket.

In yet a further broad form of the invention there is provided a device by which entities participate in a transaction and wherein said transaction incorporates at least two parameters; said device providing the entity with the ability to trade off a first parameter against a second parameter in a fully informed manner.

Preferably the first parameter is the value of a good or service.

Preferably the second parameter is the probability of gaining title to the good or service (or at least gaining the benefit of the good or service).

### BRIEF DESCRIPTION OF DRAWINGS

Embodiments of the present invention will now be described with reference to the accompanying drawings wherein:

FIG. 1 is perspective view of a dedicated hardware device in accordance with an embodiment of the present invention,

FIG. 2 is a block diagram of the main components forming a user interaction device of FIG. 1,

FIG. 3 is a block diagram of the interconnection of components which can form the system of FIG. 4 and

FIG. 4 is a block diagram of the primary components forming a system for interconnecting the interaction device of FIG. 2.

### DETAILED DESCRIPTION OF PREFERRED EMBODIMENTS

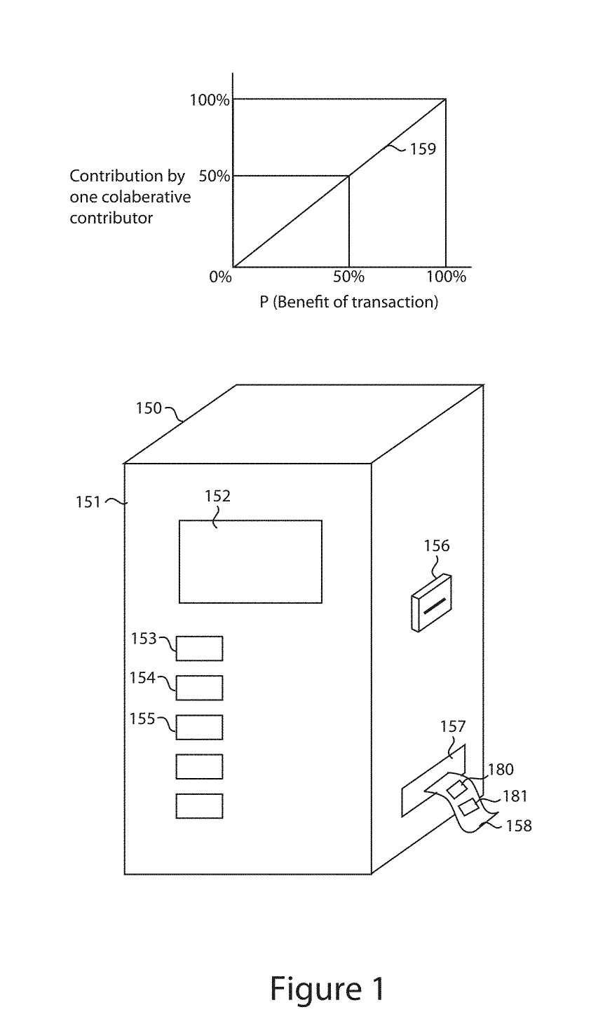

With reference to FIG. 1 there is illustrated a dedicated device 150 comprising an enclosure 151 having a display 152 and activation buttons 153, 154, 155. The device 150 also includes a card reader 156 and a ticket dispenser 157. A graphical depiction of progress of a cycle of the dedicated device of FIG. 1 can be displayed in display 152 preferably together with an indication of a predetermined time limit by which the cycle must be completed. A processor includes a timer that starts counting down the time left in the time limit and, at regular intervals the system checks to see if the predetermined time limit has expired. In use collaborative contributors activate an input button 153 in order to qualify as a collaborative contributor. The benefit of a transaction will be displayed in display 152 together with the time limit by which the transaction must be completed. The contributor may elect to participate in the transaction by purchasing one or more tickets 158 of a predetermined number of tickets available which comprise the transaction and which predetermined number will be displayed in display 152. The collaborative contributor may purchase a ticket by use of the card reader 156 which will accept credit or debit cards. A ticket 158 will then be issued to that collaborative contributor. The ticket will include on it information in the form of indicia which identifies the contribution value 180 and identity information 181 which links the ticket 158 uniquely to the contributor which purchased the ticket.

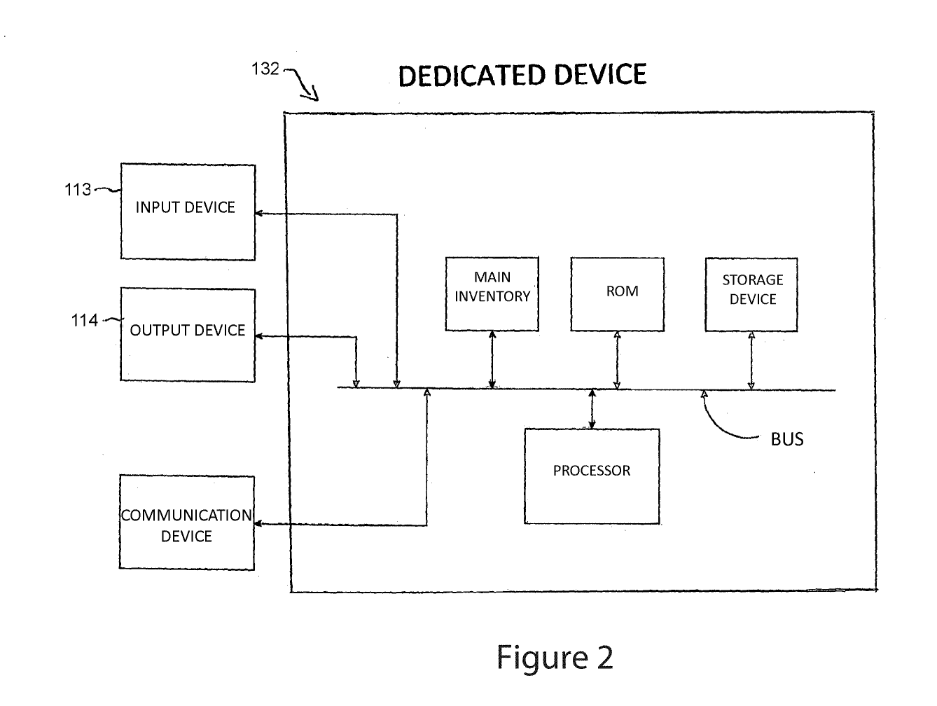

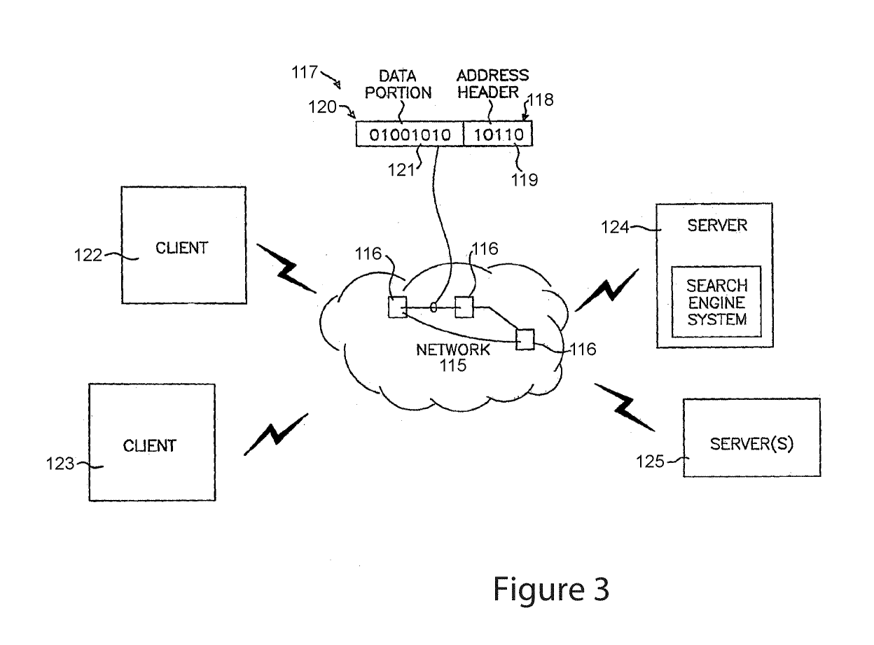

At the end of the predetermined time or before if the predetermined number of tickets 158 have been sold then display 152 will display which ticket has been awarded the benefit of the transaction. That ticket holder may then claim the benefit of the transaction. If the benefit of the transaction is a monetary amount the monetary amount may be deposited into the account associated with the card that was used to purchase the ticket that qualified for the benefit of the transaction. Other forms of benefit may need to be claimed externally to and separate from the dedicated device. In the preferred form the ticket 158 which is selected to qualify for the benefit of the transaction is selected at random from the predetermined number of tickets issued comprising the transaction. The hardware comprising the dedicated device 150 may be as illustrated and previously described with reference to FIG. 2. The dedicated device 150 may communicate over the Internet with a remote server 124 for example in accordance with the topology of FIG. 3.

The graph shown in the inset of FIG. 1 illustrates the control that a contributor has when operating the dedicated device 150 over two parameters of relevance to the contributor. On the horizontal axis a first parameter being the probability of receiving the benefit of a transaction is depicted. The parameter operates between zero and 100% where 100% indicates certainty of receipt of benefit of the transaction. The vertical axis illustrates a second parameter comprising the amount of contribution by one collaborative contributor to the target contribution amount. Again the range lies between zero and 100% where 100% indicates that one collaborative contributor has contributed the entire target contribution amount in which event, as the graph indicates, that collaborative contributor has a 100% probability of obtaining the benefit of the transaction in question. A contributor operating the device 150 may elect to operate anywhere along the characteristic curve 159 which, in this instance, is a straight line on the assumption that all increments available to a prospective collaborative contributor are equal and the probability of obtaining the benefit of transaction is equal to the value of one increment divided by the value of all of the increments making up the target contribution amount. Where each increment is represented by one ticket purchased on the device 150 each ticket has an equal probability to any other ticket of being selected as the ticket which provides the benefit of the transaction.

There may be scenarios where the device is constructed in such a way that other probability profiles are provided.

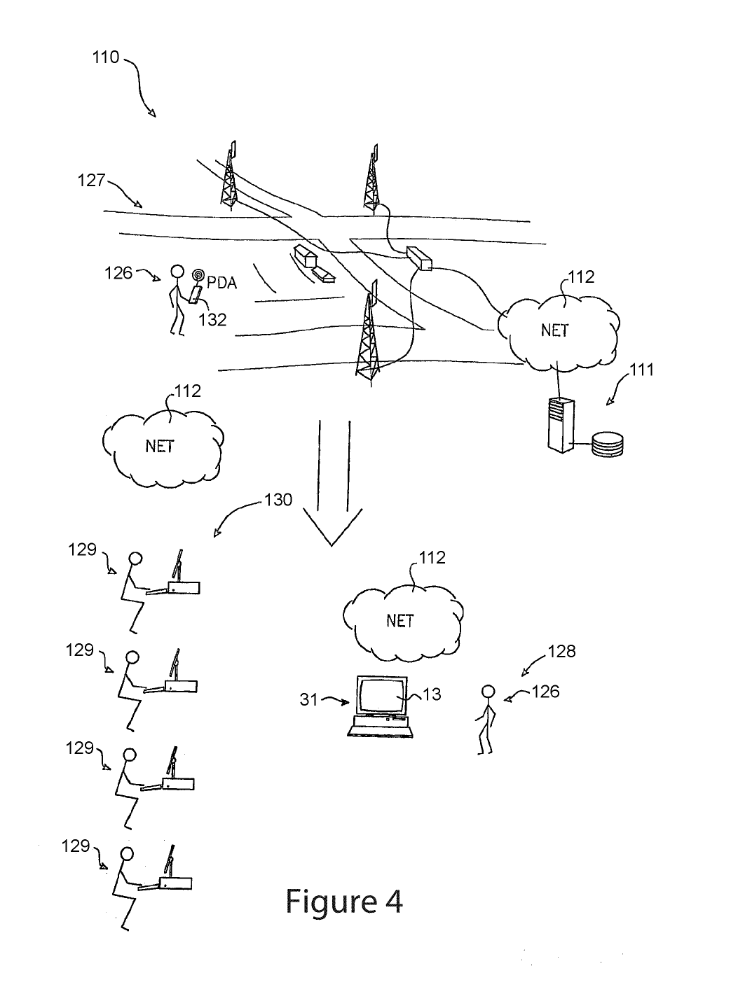

With reference to FIG. 4 there is illustrated a topology of a system in accordance with a further preferred embodiment of the present invention which can be applied to and by which any of the previously described embodiments may be implemented. In this instance, there is illustrated a distributed system 110 comprising a database 111 in communication with the internet 112.

By way of the internet 112, the database is also in communication with at least one input device 113 and at least one output device 114.

In a particular preferred form, with reference to FIG. 3, the internet 112 forms a part of or the entirety of a network or a digital network 115 comprising an interconnected network of computers 116 and wherein data is transmitted between various ones of the computers 116 forming the digital network 115 by way of packets 117, each packet having a header 118 which contains address data 119 in association with a data portion 120 having digital data 121 therein which, in effect, comprises “pay load” for the data packet 117. The data packets 117 may be transported between the interconnected network of computers according to a defined protocol. In a particular preferred form, the protocol is TCP/IP.

Input device 113 may comprise a client 122 on the network 115. Similarly, the output device 114 may also comprise a client 123 on the network 115.

Similarly, the database 111 may be implemented as part of a server 124 also connected to the digital network 115. There may be other servers 125 associated with the network. These servers may be used for example to serve web pages associated with the database 111 or provide other functionality suited to communicate with users on the network.

The client server arrangement thus far described with reference to FIG. 3 as applied to the system of FIG. 4 can be implemented so as to permit communication between a purchaser 126 armed with a special purpose digital device 132 (in this instance in the form of a personal digital assistant programmed to run a collaborative purchase application) and database 111.

In a particular form, the purchaser 126 can move between an onsite location 127 and a fixed office location 128 remote from the onsite location 127.

The system 110 furthermore permits communication with and input from other people who may generally be designated as collaborative contributors 129. The collaborative contributors 129 may be located at distributed or various other remote locations 130 or may be located with purchaser 126.

In preferred forms, communication with these collaborative contributors 129 may be by digital means.

The purchaser 126 may communicate by other client devices such as personal computer 131 which may comprise either an output device, an input device or, indeed, combine the functions of both for the purposes of communicating with database 111 and with collaborative contributors 129.

Whilst in many instances the entity comprising a collaborative contributor will be a person it is possible for a collaborative contributor to be a computer or other machine which participates in the transaction in an automated fashion.

The above describes only some embodiments of the present invention and modifications obvious to those skilled in the art can be made thereto without departing from the scope and spirit of the present invention.

1.-14. (canceled)

15. A dedicated device implementing time-based collaborative contributions for goods or services, said dedicated device comprising:
a computer in communication with a database containing information on goods and services
an input device in communication with the computer adapted to receive input from a plurality of users, the input device associating each user with a contribution, forming a plurality of contributions, in a predetermined amount towards a designated target contribution amount associated with one or more goods or services until a predetermined time period expires;
an output device in communication with the computer wherein responsive to a contribution being made the computer updates and displays on the output device, a numerical indicator of a proportion of the designated target contribution amount contributed; and
a timer in communication with the computer wherein responsive to the expiration of the predetermined time period and satisfaction of the designated target contribution amount, the computer randomly selects one of the plurality of contributions and thereby delivers goods or services to the user associated with the randomly selected contribution, and displays on the output device the selected one of the plurality of contributions.

16. A ticketing system utilizing the dedicated device of claim 15 wherein the ticketing system includes a predetermined number of tickets and each ticket is associated with one of the plurality of contributions and whereby the predetermined number of tickets are made available for distribution for a specified transaction for the predetermined period of time, and whereby the specified transaction must be completed by no later than said predetermined period of time, and wherein said predetermined number of tickets is publicised; and wherein said predetermined period of time is publicised; and wherein a transaction result is publicised; and wherein responsive to all of said predetermined number of tickets are distributed by said predetermined period of time then the ticketing system is adapted to randomly select one ticket and award an entity associated with that ticket distribution of the specified transaction.

17. A method for awarding benefit of a transaction to one entity of a plurality of entities that collaborate on said transaction, said method comprising:
publicising the benefit of the transaction;
publicising a predetermined period of time by which the transaction must be concluded;
publicising a predetermined number of contribution portions that comprise the transaction;
distributing said predetermined number of contribution portions to the plurality of entities within said predetermined period of time; and
responsive to said predetermined number of contribution portions being distributed by said predetermined time, selecting one contribution portion and an entity associated with that contribution portion thereby awarding benefit of the transaction.

18. The method of claim 17 wherein each of the contribution portions are equal in value and comprise, when combined, said transaction.

19. The method of claim 17 wherein probability of selecting any one contribution portion is equal to selection of any other contribution portion.

20. The method of claim 17 further comprising representing a contribution portion by a ticket.

21. The method of claim 17 further comprising providing each of the plurality of entities with an ability to trade off a first parameter against a second parameter in a fully informed manner.

22. The method of claim 21 wherein the first parameter is a value of a good or service.

23. The method of claim 21 wherein the second parameter is a probability of gaining title to a goods or service.

24. A non-transitory computer-readable storage medium tangibly embodying a program of instructions executable by a machine wherein said program of instruction comprises a plurality of program codes for awarding benefit of a transaction to one entity of a plurality of entities that collaborate on said transaction, said program of instruction comprising:
program code for publicising the benefit of the transaction;
program code for publicising a predetermined period of time by which the transaction must be concluded;
program code for publicising a predetermined number of contribution portions that comprise the transaction;
program code for distributing said predetermined number of contribution portions to the plurality of entities within said predetermined period of time; and
responsive to said predetermined number of contribution portions being distributed by said predetermined time, program code for selecting one contribution portion and an entity associated with that contribution portion thereby awarding benefit of the transaction.

25. The non-transitory computer readable medium of claim 24 further comprising program code for providing each of the plurality of entities with the ability to trade off a first parameter against a second parameter in a fully informed manner.

26. The non-transitory computer readable medium of claim 25 wherein the first parameter is the value of a good or service.

27. The non-transitory computer readable medium of claim 25 wherein the second parameter is a probability of gaining title to a good or service.
